(19) United States
(12) Patent Application Publication
(10) Pub. No.: US 2014/0298354 A1
(43) Pub. Date: Oct. 2, 2014

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Miho Higano, Yokohama-shi (JP)

(21) Appl. No.: 14/226,683

(22) Filed: Mar. 26, 2014

(30) Foreign Application Priority Data
Mar. 29, 2013 (JP) 2013-073339

(51) Int. Cl. G06F 9/54

(52) U.S. Cl. CPC G06F 9/54
USPC 719/313

(57) ABSTRACT

An information processing apparatus includes a processing execution unit related to execution of continuous sequential processing executed by a plurality of components. The processing execution unit includes a communication unit configured to communicate a message including identification information for identifying the continuous sequential processing, with another processing execution unit, a recording unit configured to record recorded information of the continuous sequential processing including the identification information included in the message communicated through the communication unit, in a memory area, and an output unit configured to obtain and output the recorded information including the identification information from the recorded information recorded in the memory area, based on the identification information included in the message communicated through the communication unit.

### BACKGROUND OF THE INVENTION

1. Field of the Invention

The present disclosure generally relates information processing and, more particularly, to an information processing apparatus, an information processing method, and a storage medium.

2. Description of the Related Art

Conventionally, an image processing apparatus generally executes a plurality of processes (sequence processing) in stages. A log indicating how the process is executed in each stage, and a log indicating how a processing result in each stage affects other stages are useful in error analysis. The accuracy and the visibility of the log are generally in a tradeoff relation.

Thus, Japanese Patent Application Laid-Open No. 2008-15733 discusses a technique in which a first apparatus transmits an identifier for identifying sequence processing together with a request to a second apparatus, and the second apparatus transmits the identifier together with a reply to the first apparatus. Thus, in the technique discussed in Japanese Patent Application Laid-Open No. 2008-15733, the first apparatus outputs log information of sequential sequence processing among pieces of log information accumulated in the second apparatus, based on the identifier.

However, in the technique discussed in Japanese Patent Application Laid-Open No. 2008-15733, the identifier for identifying the sequence processing is not transmitted in message communications between a plurality of components, when the processing is executed in stages in the plurality of components. Thus, in the technique discussed in Japanese Patent Application Laid-Open No. 2008-15733, the log information is difficult to be output from a plurality of components by identifying the processing executed in each stage in the plurality of components as the continuous sequential sequence processing.

### SUMMARY OF THE INVENTION

The present disclosure is directed to a technique for outputting recorded information of continuous sequential processing executed in a plurality of components with high visibility.

According to an aspect of the present disclosure, an information processing apparatus including a processing execution unit related to execution of continuous sequential processing executed by a plurality of components, the processing execution unit includes a communication unit configured to communicate a message including identification information for identifying the continuous sequential processing, with another processing execution unit, a recording unit configured to record recorded information of the continuous sequential processing including the identification information included in the message communicated through the communication unit, in a memory area, and an output unit configured to obtain and output the recorded information including the identification information from the recorded information recorded in the memory area, based on the identification information included in the message communicated through the communication unit.

Further features of the present disclosure will become apparent from the following description of exemplary embodiments with reference to the attached drawings.

### BRIEF DESCRIPTION OF THE DRAWINGS

FIG. 1 is a diagram illustrating an example of a hardware configuration of a log output apparatus.

FIG. 2 is a diagram illustrating an example of a functional configuration of the log output apparatus.

FIG. 3 is a table illustrating an example of log information.

FIG. 4 is a table illustrating an example of log information.

FIG. 5 is a table illustrating an example of log output request destination information.

FIG. 6 is a flowchart illustrating an example of processing according to a first and other exemplary embodiments.

FIG. 7 is a table illustrating an example of an output log level.

FIG. 8 is a flowchart illustrating an example of processing according to a fourth exemplary embodiment.

### DESCRIPTION OF THE EMBODIMENTS

Various exemplary embodiments, features, and aspects of the disclosure will be described in detail below with reference to the drawings.

According to a first exemplary embodiment, a log output apparatus stores (records) log information in a memory area for each component. The log information is associated with sequence identification information (hereinbelow, referred to as sequence identifier) for identifying sequence processing as continuous sequential processing. Then, the log output apparatus outputs the log information associated with the sequence identifier from the memory area, when the sequence processing is completed. The above-described processing is described in detail below. The log output apparatus is an example of an information processing apparatus, and the component is an example of a processing execution unit. As used herein, the term “unit” generally refers to any combination of software, firmware, hardware, or other component that is used to effectuate a purpose.

The sequence processing herein is continuous sequential processing including processing executed in stages by a plurality of components. The log information herein is recorded information related to the processing executed in stages by the component. Specifically, the log information is recorded information related to execution of each process in the sequence processing.

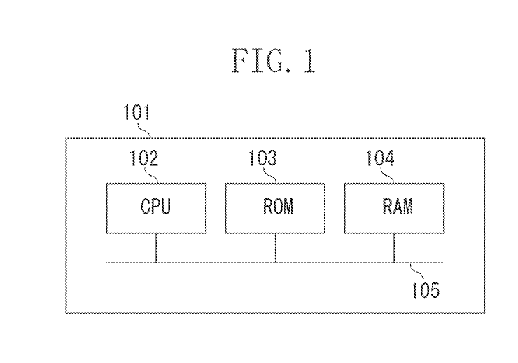

FIG. 1 is a diagram illustrating an example of a hardware configuration of a log output apparatus 101 according to the present exemplary embodiment. The log output apparatus 101 according to the present exemplary embodiment may be realized by a single computer device or a plurality of appropriate computer apparatuses. In the latter case, the functions of the log output apparatus 101 are distributed among the plurality of computer apparatuses, connected to each other through a Local Area Network (LAN) or a bus, so as to be able to communicate with each other.

The log output apparatus 101 includes a central processing unit (CPU) 102, a read only memory (ROM) 103, a random access memory (RAM) 104, and a bus 105.

The CPU 102 controls the entire log output apparatus 101. The CPU 102 loads a program stored in the ROM 103 onto the RAM 104, and executes the program. Thus, the CPU 102 executes the program to realize the functions (software configuration) of the log output apparatus 101, the functions of the operating system (OS), and processing related to flowcharts, which will be described below.

The ROM 103 stores a program and a parameter that need not to be changed.

The RAM 104 functions as a work memory that temporary stores a program and data.

The bus 105 is a system bus. The CPU 102, the ROM 103, and the RAM 104 are connected with each other through the buns 105, so as to be able to communicate with each other.

The log output apparatus 101 may include an input interface for an input device. The input device is a pointing device or a keyboard operated by a user to input data. The log output apparatus 101 may include an output interface. The output interface displays data held by the log output apparatus 101 or supplied data. The log output apparatus 101 may include a network interface for connecting the log output apparatus 101 to a network line such as the Internet. The log output apparatus 101 may include a storage device including a hard disk and a memory card, fixedly disposed in the log output apparatus 101. The log output apparatus 101 may further include a removable storage device including an optical disk, such as a flexible disk (FD) and a compact disk (CD), a magnetic card, an optical card, an integrated circuit (IC) card, and a memory card.

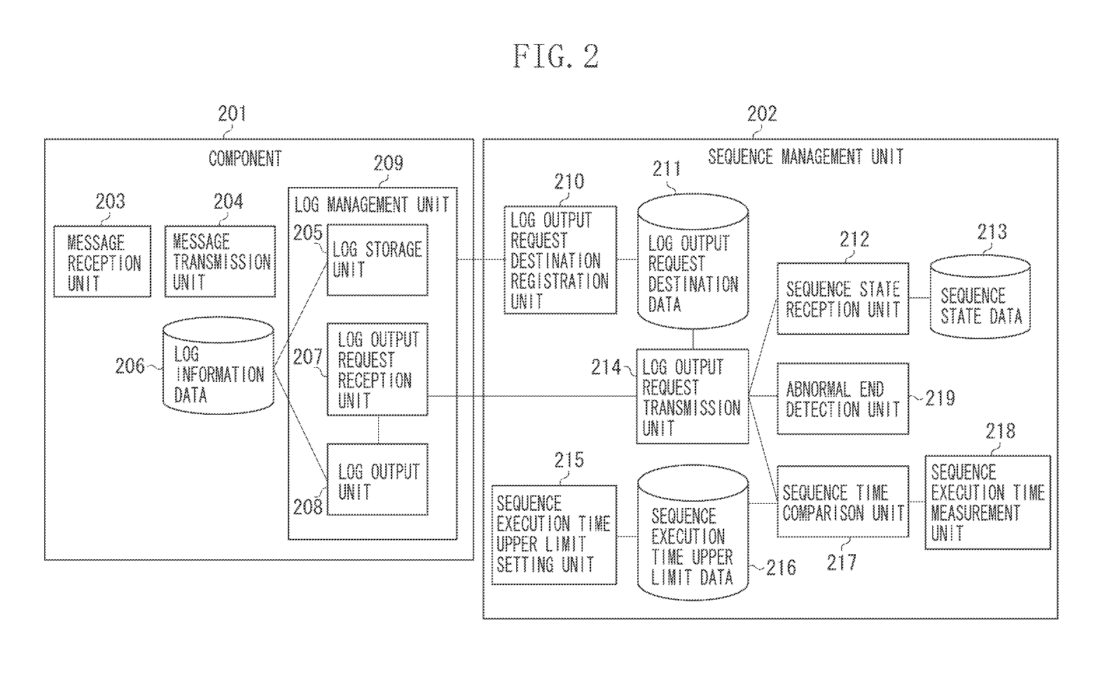

FIG. 2 is a diagram illustrating an example of a functional configuration of the log output apparatus 101.

The log output apparatus 101 includes a component 201 and a sequence management unit 202. The component 201 provides functions described below. The sequence management unit 202 manages the sequence processing, and specifically manages the sequence processing executed in a plurality of the components 201.

The component 201 includes a message reception unit 203, a message transmission unit 204, and a log management unit 209, as a functional configuration. The log management unit 209 includes a log storage unit 205, a log output request reception unit 207, and a log output unit 208 as a functional configuration. The component 201 further includes a log information data 206 as a functional configuration.

An execution unit in the component 201 according to the present exemplary embodiment is per-program basis (hereinbelow, referred to as a process). The OS allocates a memory area to the program unit, and the CPU 102 executes processing based on the program unit. A plurality of the processes operates in the log output apparatus 101.

The message reception unit 203 receives a message including a sequence identifier for identifying sequence processing. The sequence identifier may be an identifier uniquely allocated in a system, or an identifier uniquely allocated in a predetermined namespace.

The message transmission unit 204 transmits a message including the sequence identifier.

The component 201 includes at least one of the message reception unit 203 and the message transmission unit 204. Thus, with the sequence identifier, the component 201 can identify the sequence processing executed in a plurality of the components 201.

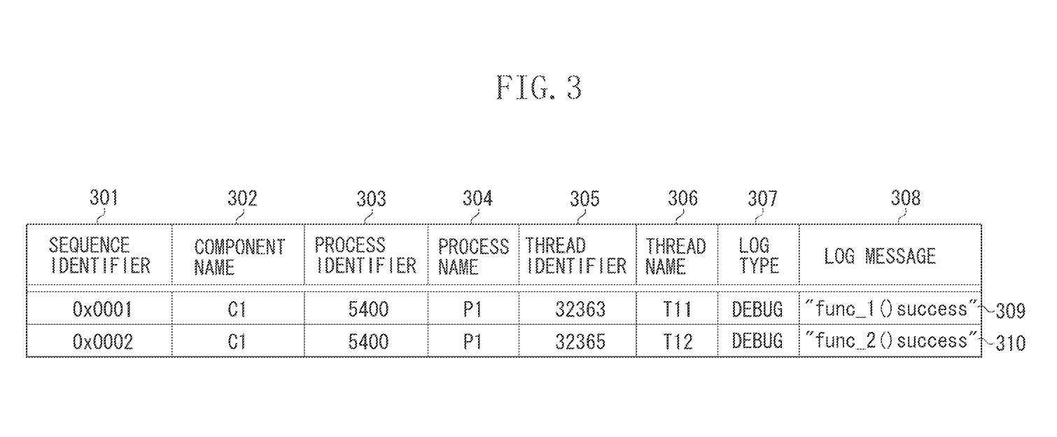

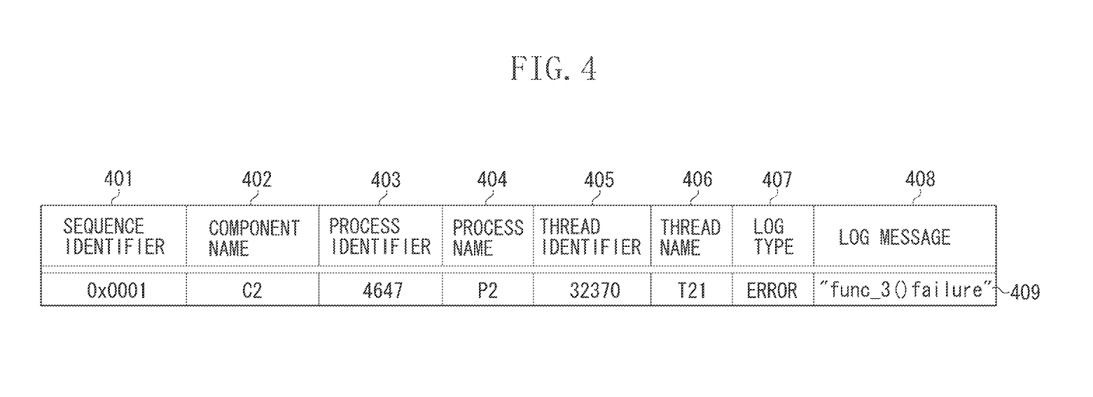

The log storage unit 205 stores the log information including the sequence identifier, in the RAM 104. The log information will be described below by referring to FIGS. 3 and 4, as well as other figures.

The log information data 206 includes at least one log information. In the present exemplary embodiment, the log storage unit 205 stores the log information including the sequence identifier, in the memory area (hereinbelow, referred to as a heap memory area) allocated to the process by the OS.

The log output request reception unit 207 receives a log output request including the sequence identifier.

Here, the component 201 uses a log output request destination registration unit 210 described below, to register the own log output request destination in the sequence management unit 202. The component 201 receives the log output request through the log output request reception unit 207, and then outputs the log information from the log information data 206 through the log output unit 208 described below.

The log output unit 208 selects the log information corresponding to the sequence identifier included in the log output request, from the log information data 206. Then, the log output unit 208 outputs the thus obtained log information to the log output destination. The log output destination may be the output device, a shared memory area shared in the system, or any other apparatuses that can be communicated through the network.

The sequence management unit 202 includes a log output request destination registration unit 210, a sequence state reception unit 212, an abnormal end detection unit 219, a sequence time comparison unit 217, a sequence execution time measurement unit 218, and a sequence execution time upper limit setting unit 215, as a functional configuration. The sequence management unit 202 further includes log output request destination data 211, sequence state data 213, and sequence execution time upper limit data 216, as a functional configuration. The sequence state data 213 is an example of processing information of the sequence processing.

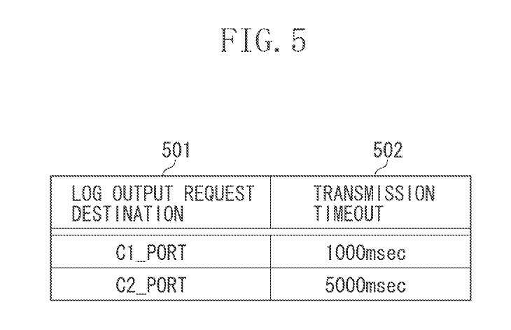

The log output request destination registration unit 210 registers the destination of the log output request. Here, the log output request destination registration unit 210 stores destination information in the RAM 104, as the log output request destination data 211. The destination information (hereinbelow referred to as log output request destination information) is used for transmitting the log output request to the component 201. The log output request destination information includes information on a communication end point for message transmission and information on a communication condition. The log output request destination information will be described below by referring to FIG. 5.

The log output request destination data 211 includes at least one log output request destination information. In the present exemplary embodiment, the log output request destination registration unit 210 stores the log output request destination data 211 in the heap memory area.

The sequence state reception unit 212 receives information hereinbelow indicating the processing state of the sequence processing (hereinbelow, referred to as state information).

The sequence state data 213 includes at least one data set, in which the sequence identifier and the state information are associated. In the present exemplary embodiment, the sequence management unit 202 stores the sequence state data 213 in the heap memory area.

The sequence management unit 202 receives the sequence identifier and the state information indicating the end of the sequence processing. Then, the sequence management unit 202 transmits the log output request including the sequence identifier to the component 201, based on the log output request destination data 211.

The log output request transmission unit 214 transmits the log output request including the sequence identifier to the component 201, based on the log output request destination data 211.

With the function described above, the log output apparatus 101 can output the log information associated with the sequence identifier for identifying the sequence processing from the memory area, when the sequence processing is completed.

The functions of the sequence execution time upper limit setting unit 215, the abnormal end detection unit 219, the sequence time comparison unit 217, and the sequence execution time measurement unit 218, as well as the sequence execution time upper limit data 216 will be described in exemplary embodiments described below.

The log information data 206 will be described by referring to FIGS. 3 and 4.

FIG. 3 is a table illustrating an example of the log information stored, as the log information data 206, in the heap memory area by the component 201 hereinbelow with the component name “C1” (hereinbelow, referred to as component C1).

A sequence identifier 301 indicates the identification information for identifying the sequence processing as described above.

A component name 302 indicates the name information of the component.

A process identifier 303 indicates identifier information allocated by the OS to identify a process.

A process name 304 indicates name information of a process given by the OS or a developer.

A thread identifier 305 indicates an identifier allocated by the OS to identify a minimum execution unit (thread) of the program.

A thread name 306 indicates name information of a thread given by the OS or the developer.

A log type 307 indicates type information of the log. In the present exemplary embodiment, the type of the log output when the error has occurred is defined as “ERROR”, and the type of the log output for analyzing an operation is defined as “DEBUG”.

A log message 308 indicates log message information. More specifically, log information 309 indicates the log message information related to a sequence identifier “0×0001”. Log information 310 indicates the log message information related to a sequence identifier “0×0002”.

FIG. 4 is a table illustrating an example of the log information stored, as the log information data 206, in the heap memory area by the component 201 hereinbelow with the component name “C2” (hereinbelow, referred to as component C2).

Information indicated by 401 to 408 in FIG. 4 is the same as the information indicated by 301 to 308 in FIG. 3, and thus will not be descried.

Log information 409 indicates the log message information related to the sequence identifier “0×0001”.

The component 201 performs the following operations when the sequence management unit 202 transmits the log output request including the sequence identifier “0×0001”, to the component 201.

The component 201 searches for and selects the log information 309 or the log information 409 associated with the sequence identifier “0×0001”, in the log information data 206. More specifically, the component C1 searches for and selects the log information 309, and the component C2 searches for and selects the log information 409. Furthermore, the component 201 outputs the selected log information to the log output destination, and deletes the log information 309 or the log information 409, from the log information data 206, stored as the log information data 206 in the heap memory area. More specifically, the component C1 deletes the log information 309 stored in the heap memory area, and the component C2 deletes the log information 409 stored in the heap memory area.

The log output request destination data 211 will be described by referring to FIG. 5.

FIG. 5 is a table illustrating an example of the log output request destination information.

A log output request destination 501 indicates address information to transmit the message from the sequence management unit 202 to the component 201 for the log output requests.

A transmission timeout 502 indicates transmission timeout time information of the message transmission from the sequence management unit 202 to the component 201. The sequence management unit 202 transmits the log output request including the sequence identifier to the component 201, based on the address information indicated by the log output request destination 501 and the transmission timeout time information indicated by the transmission timeout 502. Here, the sequence management unit 202 outputs an error message when the transmission time of the message transmission for the log output request exceeds the timeout time.

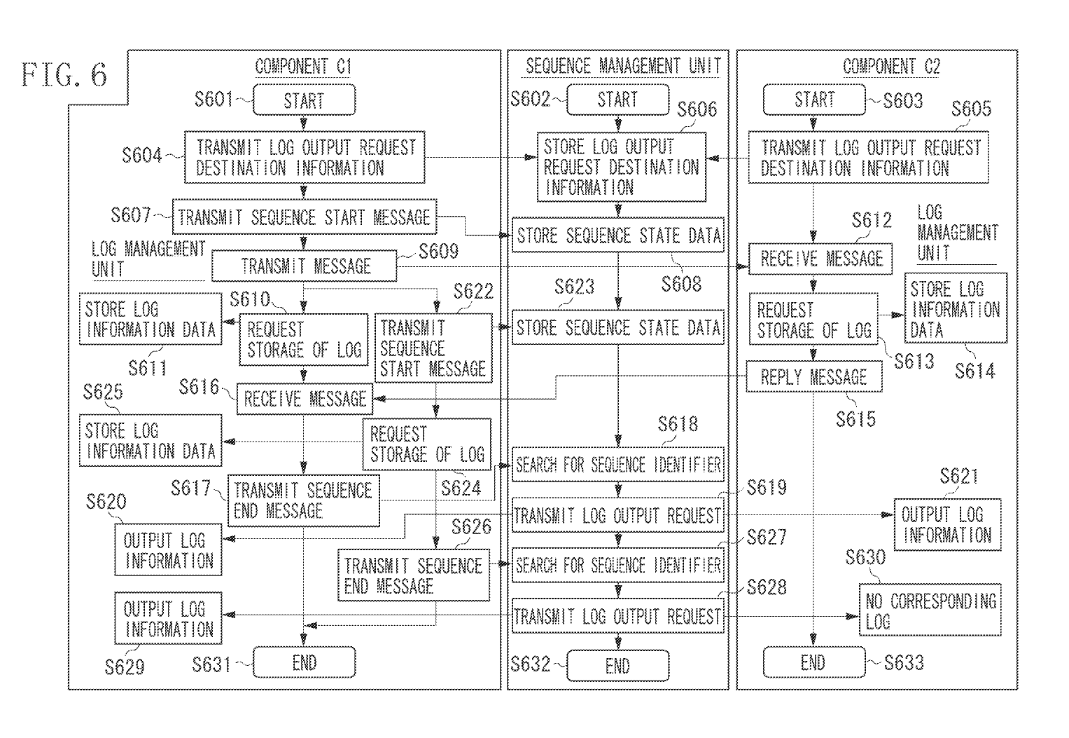

The flow of processing in the present exemplary embodiment will be described by referring to FIG. 6.

FIG. 6 is a flowchart illustrating an example of the processing according to the present exemplary embodiment.

The component C1 starts the processing in step S601. The sequence management unit 202 starts the processing in step S602. The component C2 starts the processing in step S603.

In step S604, the component C1 transmits the log output request destination information to the sequence management unit 202. The log output request destination information includes information of the own address “C1_PORT” as the destination of the log output request and the transmission timeout time “1000 msec”.

In step S605, the component C2 transmits the log output request destination information to the sequence management unit 202, as in step S604. The log output request destination information includes information of the own address “C2_PORT” as the destination of the log output request and the transmission timeout time “5000 msec”.

In step S606, the sequence management unit 202 stores the received log output request destination information (as illustrated in FIG. 5) as the log output request destination data 211, in the heap memory area.

In step S607, the component C1 transmits the sequence identifier “0×0001” and the state information “start” to the sequence management unit 202, to perform notification that a first sequence processing has started.

In step S608, the sequence management unit 202 associates the sequence identifier “0×0001” with the state information “start”, and stores the resultant data as the sequence state data 213 in the heap memory area.

In step S609, the component C1 transmits a message including the sequence identifier “0×0001” to the component C2.

In step S610, the component C1 requests the log management unit 209 of the component C1 to store the log information 309.

In step S611, the log management unit 209 of the component C1 associates the sequence identifier “0×0001” with the log information 309, and stores the resultant data as the log information data 206 in the heap memory area.

In step S612, the component C2 receives the message including the sequence identifier “0×0001” from the component C1.

In step S613, the component C2 requests the log management unit 209 of the component C2 to store the log information 409.

In step S614, the log management unit 209 of the component C2 associates the sequence identifier “0×0001” with the log information 409, and stores the resultant data as the log information data 206 in the heap memory area.

In step S615, the component C2 transmits a reply message including the sequence identifier “0×0001” to the component C1.

In step S616, the component C1 receives the reply message including the sequence identifier “0×0001” from the component C2.

In step S617, the component C1 transmits the sequence identifier “0×0001” and the state information “end” to the sequence management unit 202, to perform notification that the first sequence processing is completed.

In step S618, the sequence management unit 202 searches the sequence state data 213 for the received sequence identifier “0×0001”. If the corresponding sequence identifier exists, the processing proceeds to step S619. If the corresponding sequence identifier does not exist, the processing proceeds to step S627.

In step S619, the sequence management unit 202 transmits the log output request including the sequence identifier “0×0001” to the components C1 and C2, based on the log output request destination data 211.

In step S620, the component C1 searches for and selects the log information 309 associated with the sequence identifier “0×0001” from the log information data 206, and outputs the log information 309 to the log output destination. The component C1 deletes the log information 309 stored in the heap memory area as the log information data 206.

In step S621, the component C2 searches for and selects the log information 409 associated with the sequence identifier “0×0001” from the log information data 206, and outputs the log information 409 to the log output destination, as in step S620. The component C2 deletes the log information 409 stored in the heap memory area as the log information data 206.

In step S622, the component C1 transmits the sequence identifier “0×0002” and the state information “start” to the sequence management unit 202, to perform notification that a second sequence processing has started.

In step S623, the sequence management unit 202 associates the sequence identifier “0×0002” with the state information “start”, and stores the resultant data as the sequence state data 213 in the heap memory area.

In step S624, the component C1 requests the log management unit 209 of the component C1 to store the log information 310.

In step S625, the sequence log unit 209 of the component C1 stores the log information 310 in the heap memory area, as the log information data 206.

In step S626, the component C1 transmits the sequence identifier “0×0002” and the state information “end” to the sequence management unit 202, to perform notification that the second sequence processing is completed.

In step S627, the sequence management unit 202 searches the sequence state data 213 for the received sequence identifier “0×0002”. If the corresponding sequence identifier exists, the processing proceeds to step S628. If the corresponding sequence identifier does not exist, the processing proceeds to step S632.

In step S628, the sequence management unit 202 transmits the log output request including the sequence identifier “0×0002” to the components C1 and C2, based on the log output request destination data 211.

In step S629, the component C1 searches for and selects the log information 310 associated with the sequence identifier “0×0002” from the log information data 206, and outputs the log information 310 to the log output destination. The component C1 deletes the log information 310 stored in the heap memory area as the log information data 206.

In step S630, the component C2 searches for and selects the log information associated with the sequence identifier “0×0002” from the log information data 206. According to the present exemplary embodiment, the corresponding log information does not exist, and thus the component C2 does not output any log. Then, the processing proceeds to step S633.

The component C1 terminates the processing in step S631. The sequence management unit 202 terminates the processing in step S632. The component C2 terminates the processing in step S633.

According to the present exemplary embodiment, the component 201 transmits the log output request destination information to the sequence management unit 202 for requesting the sequence management unit 202 to register the component 201 as the log output request destination, when the component 201 is initialized. Alternatively, the component 201 may transmit the log output request destination information to the sequence management unit 202 for requesting the sequence management unit 202 to register the component 201 as the log output request destination, while executing the sequence processing.

According to the present exemplary embodiment described above, the log information of the sequential sequence processing identified as the continuous sequential sequence processing. Thus, the log output deice 101 can output the log information with high visibility.

In a second exemplary embodiment, the log output apparatus 101 stores log information associated with a sequence identifier in a memory area, for each component. Then, the log output apparatus 101 outputs log information corresponding to the sequence identifier from the memory area, in accordance with a processing result of sequence processing. The above described processing will be described in detail below.

The log output apparatus 101 according to the present exemplary embodiment has the same hardware configuration as that in the first exemplary embodiment.

A point of the functional configuration of the log output device 101 according to the present exemplary embodiment illustrated in FIG. 2 different from the above described exemplary embodiment will be described.

The component 201 transmits information indicating processing result of the sequence processing (hereinbelow, referred to as result information), the sequence identifier, and the state information to the sequence management unit 202. The sequence management unit 202 determines whether to transmit the log output request including the sequence identifier to the component 201, in accordance with the processing result of the sequence processing.

The sequence state reception unit 212 receives the result information, the sequence identifier, and the state information.

The sequence state data 213 includes at least one data set in which the sequence identifier, the result information, and the state information are associated with each other. According to the present exemplary embodiment, the sequence management unit 202 stores the sequence state data 213 in the heap memory area.

The log output request transmission unit 214 determines whether to transmit the log output request in accordance with the processing result of the sequence processing. Upon determining to transmit the log output request, the log output request transmission unit 214 transmits the log output request including the sequence identifier to the component 201, based on the log output request destination data 211. Upon determining not to transmit the log output request, the log output request transmission unit 214 transmits a log deletion request including the sequence identifier to the component 201, based on the log output request destination data 211.

The flow of processing in the present exemplary embodiment will be described by referring to FIG. 6.

The processing in steps S601 to S615 is the same as that in the first exemplary embodiment.

It is assumed here that, in step S616, the component C1 has failed to receive the reply message from the component C2.

In step S617, the component C1 transmits the result information “failure”, the sequence identifier “0×0001”, and the state information “end” to the sequence management unit 202, to perform notification that the first sequence processing has failed.

In step S618, the sequence management unit 202 searches the sequence state data 213 for the received sequence identifier “0×0001”. If the corresponding sequence identifier exists, the processing proceeds to step S619. If the corresponding sequence identifier does not exist, the processing proceeds to step S627.

In step S619, the sequence management unit 202 determines whether to transmit the log output request, based on the processing result of the sequence processing. According to the present exemplary embodiment, the sequence management unit 202 transmits the log output request when the processing result of the sequence processing is “failure”. The sequence management unit 202 transmits the log deletion request when the processing result of the sequence processing is “success”. Specifically, the sequence management unit 202 determines to transmit the log output request, based on the result information “failure” received in step S618. The sequence management unit 202 transmits the log output request including the sequence identifier “0×0001” to the components C1 and C2, based on the log output request destination data 211.

In step S620, the component C1 searches for and selects the log information 309 associated with the sequence identifier “0×0001”, from the log information data 206, and outputs the log information 309 to the log output destination. The component C1 deletes the log information 309 stored in the heap memory area as the log information data 206.

In step S621, the component C2 searches for and selects the log information 409 associated with the sequence identifier “0×0001”, from the log information data 206, and outputs the log information 409 to the log output destination, as in step S620. The component C2 deletes the log information 409 stored in the heap memory area as the log information data 206.

The processing in steps S622 to S625 is the same as that in the first exemplary embodiment.

In step S626, the component C1 transmits the result information “success”, the sequence identifier “0×0002”, and the state information “end” to the sequence management unit 202, to perform notification that the second sequence processing has been successful.

In step S627, the sequence management unit 202 searches the sequence state data 213 for the received sequence identifier “0×0002”. If the corresponding sequence identifier exists, the processing proceeds to step S628. If the corresponding sequence identifier does not exist, the processing proceeds to step S632.

In step S628, the sequence management unit 202 determines whether to transmit the log output request, based on the processing result of the sequence processing. The sequence management unit 202 determines not to transmit the log output request, based on the result information “success” received in step S627. The sequence management unit 202 transmits the log deletion request including the sequence identifier “0×0002” to the components C1 and C2, based on the log output request destination data 211.

In step S629, the component C1 searches for and selects the log information 310 associated with the sequence identifier “0×0002”, from the log information data 206. The component C1 deletes the log information 310 stored in the heap memory area as the log information data 206.

The processing in steps S630 to S633 is the same as that in the first exemplary embodiment.

According to the present exemplary embodiment described above, the log output apparatus 101 selects the log information of the sequential sequence processing in accordance with the processing result of the sequence processing. Thus, the log information is identified as the continuous sequential sequence processing, and the log output apparatus 101 can accurately output the log information with high visibility.

In a third exemplary embodiment, the log output apparatus 101 stores log information associated with a sequence identifier in a memory area, for each component. The log output apparatus 101 determines an output log level in accordance with a processing result of sequence processing. Then, the log output apparatus 101 outputs the log information corresponding to the sequence identifier in accordance with the determined output level, from the memory area. The above described processing will be described in detail below.

The log output apparatus 101 according to the present exemplary embodiment has the same hardware configuration as that in the first exemplary embodiment.

Next, a point of the functional configuration of the log output device 101 according to the present exemplary embodiment illustrated in FIG. 2 different from the above described exemplary embodiments will be described.

The component 201 transmits the result information, the sequence identifier, and the state information to the sequence management unit 202.

The sequence management unit 202 determines the output log level in accordance with the processing result of the sequence processing. Then, the sequence management unit 202 transmits a log output request including the sequence identifier and information hereinbelow indicating the output log level (hereinbelow, referred to as output log level information) to the component 201.

The log output request reception unit 207 receives the log output request including the sequence identifier and the output log level information.

The log output unit 208 selects the log information corresponding to the sequence identifier and the output log level included in the log output request, from the log information data 206. Then, the log output unit 208 outputs the selected log information to the log output destination.

The sequence state reception unit 212 receives the result information, the sequence identifier, and the state information.

The sequence state data 213 includes at least one data set in which the sequence identifier, the result information, and the state information are associated with each other. According to the present exemplary embodiment, the sequence management unit 202 stores the sequence state data 213 in the heap memory area.

The log output request transmission unit 214 determines the output log level in accordance with the processing result of the sequence processing. Then, the log output request transmission unit 214 transmits the log output request including the sequence identifier and the output log level information to the component 201, based on the log output request destination data 211.

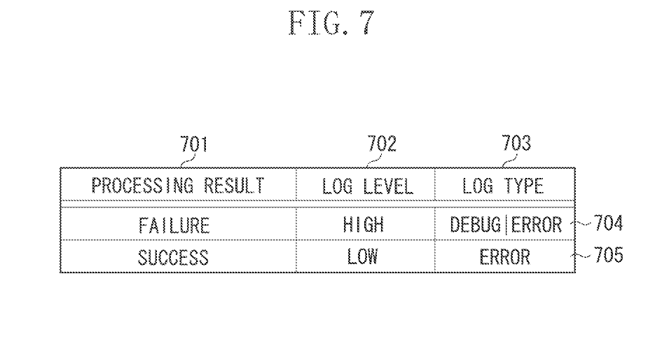

The output log level determined by the sequence management unit 202 according to the present exemplary embodiment is described by referring to FIG. 7.

FIG. 7 is a table illustrating an example of relationships among the processing result, the output log level information, and the log type.

A processing result 701 indicates the processing result information as the processing result of the sequence processing.

An output log level 702 indicates the output log level information.

A log type 703 is information hereinbelow indicating the output log type (hereinbelow, referred to as output log type information).

A log type 704 indicates that, when the processing result of the sequence processing is “failure”, the output log level is “HIGH” and the log type output by the log output unit 208 is “ERROR” and “DEBUG”.

A log type 705 indicates that, when the processing result of the sequence processing is “success”, the output log level is “LOW” and the log type output by the log output unit 208 is “ERROR”.

The flow of processing according to the present exemplary embodiment will be described by referring to FIG. 6.

The processing in steps S601 to S615 is the same as that in the first exemplary embodiment.

It is assumed here that, in step S616, the component C1 has failed to receive the reply message from the component C2.

In step S617, the component C1 transmits the result information “failure”, the sequence identifier “0×0001”, and the state information “end” to the sequence management unit 202, to perform notification that the first sequence processing has failed.

In step S618, the sequence management unit 202 searches the sequence state data 213 for the received sequence identifier “0×0001”. If the corresponding sequence identifier exists, the processing proceeds to step S619. If the corresponding sequence identifier does not exist, the processing proceeds to step S627.

In step S619, the sequence management unit 202 determines the output log level, based on the processing result of the sequence processing. In the present exemplary embodiment, the sequence management unit 202 determines the output log level as “HIGH” when the processing result of the sequence processing is “failure”. The sequence management unit 202 determines the output log level as “LOW” when the processing result of the sequence processing is “success”. That is, the sequence management unit 202 determines the output log level as “HIGH”, based on the result information “failure” received in step S618. The sequence management unit 202 transmits the log output request including the sequence identifier “0×0001” and the output log level information “HIGH” to the components C1 and C2, based on the log output request destination data 211.

In step S620, the component C1 searches for and selects the log information associated with the sequence identifier “0×0001”, from the log information data 206. Then, the component C1 searches for and selects the log information associated with the log type (i.e., “ERROR” and “DEBUG”) corresponding to the output log level “HIGH” from the selected log information. Then, the component C1 outputs the selected log information to the log output destination. The component C1 deletes the selected log information stored in the heap memory area as the log information data 206.

In step S621, the component C2 searches for and selects the log information associated with the sequence identifier “0×0001”, from the log information data 206, as in step S620. Then, the component C2 searches and selects the log information corresponding to the log type (i.e., “ERROR” and “DEBUG”) associated with the output log level “HIGH” from the selected log information. Then, the component C2 outputs the selected log information to the log output destination. The component C2 deletes the selected log information stored in the heap memory area as the log information data 206.

The processing in steps S622 to S625 is the same as that in the first exemplary embodiment.

In step S626, the component C1 transmits the result information “success”, the sequence identifier “0×0002”, and the state information “end” to the sequence management unit 202, to perform notification that the second sequence processing has been successful.

In step S627, the sequence management unit 202 searches for the received sequence identifier “0×0002” from the sequence state data 213. If the corresponding sequence identifier exists, the processing proceeds to step S628. If the corresponding sequence identifier does not exist, the processing proceeds to step S632.

In step S628, the sequence management unit 202 determines the output log level, based on the processing result of the sequence processing. More specifically, the sequence management unit 202 determines the output log level as “LOW”, based on the result information “success” received in step S627. The sequence management unit 202 transmits the log output request including the sequence identifier “0×0002” and the output log level information “LOW” to the components C1 and C2, based on the log output request destination data 211.

In step S629, the component C1 searches for and selects the log information associated with the sequence identifier “0×0002”, from the log information data 206. The component C1 searches for the log information corresponding to the log type (i.e., “ERROR”) associated with the output log level “LOW” from the selected log information. According to the present exemplary embodiment, the corresponding log information does not exist. Thus the component C1 does not output the log information. The component C1 deletes the selected log information stored in the heap memory area as the log information data 206. The processing in steps S630 to S633 is the same as that in the first exemplary embodiment.

According to the present exemplary embodiment described above, the log output apparatus 101 selects the log information of the sequential sequence processing in accordance with the output level determined based on the processing result of the sequence processing. Thus, the log information is identified as the continuous sequential sequence processing, and the log output apparatus 101 can accurately output the log information with high visibility.

In a fourth exemplary embodiment, the log output apparatus 101 stores log information associated with a sequence identifier in a memory area, for each component. The log output apparatus 101 outputs log information corresponding to the sequence identifier, in accordance with an execution time of sequence processing. The above described processing will be described in detail below.

The log output apparatus 101 according to the present exemplary embodiment has the same hardware configuration as that in the first exemplary embodiment.

A point of the functional configuration of the log output device 101 according to the present exemplary embodiment illustrated in FIG. 2 different from the above described exemplary embodiments will be described.

The component 201 sets an upper limit hereinbelow of the execution time (hereinbelow referred to as a first time) of the sequence processing in the sequence management unit 202. The information indicating the first time is an example of allowable execution time information.

The sequence management unit 202 measures a time hereinbelow elapsed after the sequence processing has started (hereinbelow, referred to as a second time). The sequence management unit 202 compares the first time with the second time, and transmits the log output request including the sequence identifier to the component 201, in accordance with the comparison result. The information indicating the second time is an example of the execution time information.

The sequence execution time upper limit setting unit 215 sets the first time.

The sequence execution time upper limit data 216 is data related to the first time. According to the present exemplary embodiment, the sequence management unit 202 stores the sequence execution time upper limit data 216 in the heap memory area.

The sequence time comparison unit 217 compares the sequence execution time upper limit data 216 (first time) with the second time.

The sequence execution time measurement unit 218 measures the second time.

The log output request transmission unit 214 transmits the log output request including the sequence identifier to the component 201, based on the comparison result of the sequence time comparison unit 217.

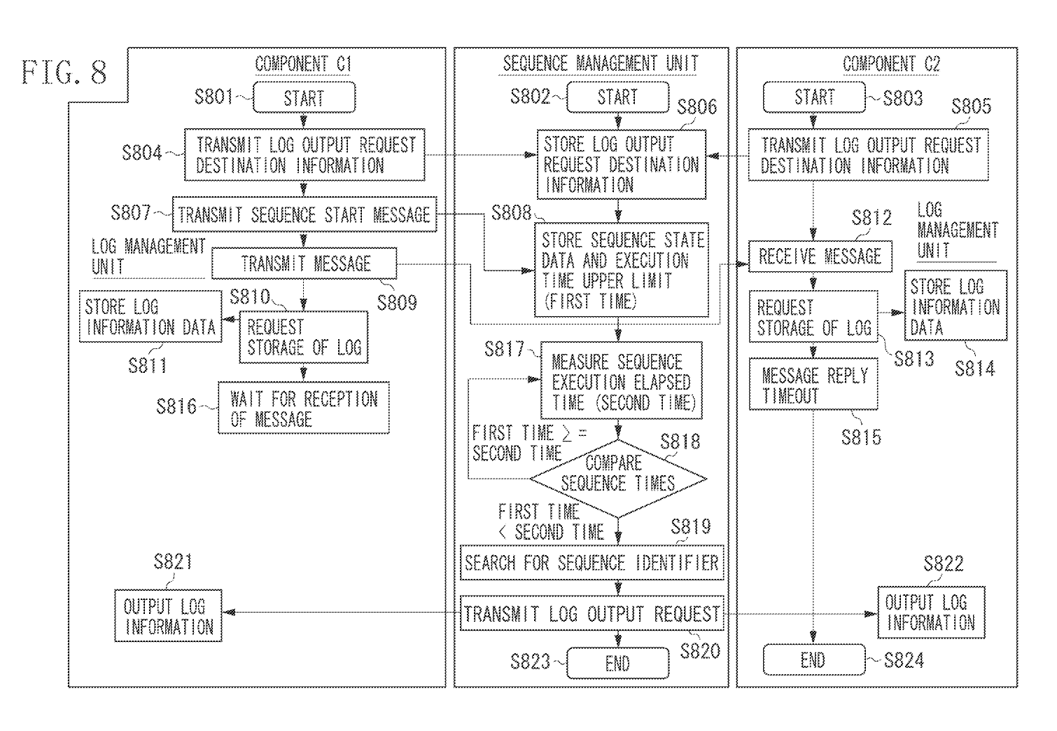

The flow of processing according to the present exemplary embodiment will be described by referring to FIG. 8.

The component C1 starts the processing in step S801. The sequence management unit 202 starts the processing in step S802. The component C2 starts the processing in step S803.

In step S804, the component C1 transmits the log output request destination information to the sequence management unit 202. The log output request destination information includes information of the own address “C1_PORT” as the destination of the log output request and the transmission timeout time “1000 msec”.

In step S805, the component C2 transmits the log output request destination information to the sequence management unit 202, as in step S804. The log output request destination information includes information of the own address “C2_PORT” as the destination of the log output request and the transmission timeout time “5000 msec”.

In step S806, the sequence management unit 202 stores the received log output request destination information, as illustrated in FIG. 5, in the heap memory as the log output request destination data 211.

In step S807, the component C1 notifies the sequence management unit 202 of the start of the first sequence processing and the upper limit of the sequence execution time. Specifically, the component C1 transmits the sequence identifier “0×0001”, the state information “start”, and the information “1000 msec” on the first time to the sequence management unit 202.

In step S808, the sequence management unit 202 associates the sequence identifier “0×0001” with the state information “start”, and stores the resultant data as the sequence state data 213 in the heap memory area. The sequence management unit 202 associates the sequence identifier “0×0001” with the information “1000 msec” on the first time, and stores the resultant data as the sequence execution time upper limit data 216 in the heap memory area.

In step S809, the component C1 transmits a message including the sequence identifier “0×0001” to the component C2.

In step S810, the component C1 requests the log management unit 209 of the component C1 to store the log information 309.

In step S811, the log management unit 209 of the component C1 associates the sequence identifier “0×0001” with the log information 309, and stores the resultant data as the log information data 206 in the heap memory area.

In step S812, the component C2 receives the message including the sequence identifier “0×0001” from the component C1.

In step S813, the component C2 requests the log management unit 209 of the component C2 to store the log information 409.

In step S814, the log management unit 209 of the component C2 associates the sequence identifier “0×0001” with the log information 409, and stores the resultant data as the log information data 206 in the heap memory area.

In step S815, the component C2 transmits the reply message including the sequence identifier “0×0001” to the component C1. According to the present exemplary embodiment, it is assumed that transmission timeout has occurred.

In step S816, the component C1 attempts to receive a reply message under a condition of no timeout time, and blocks the transmitted reply message including the sequence identifier “0×0001”.

In step S817, the sequence management unit 202 measures the second time.

In step S818, the sequence management unit 202 compares the time indicated by the sequence execution time upper limit data 216 stored in step S808 with the sequence execution elapsed time measured in step S817. If the second time is longer than the first time, the processing proceeds to step S819. If the second time is shorter than the first time (the second time is equal to or shorter than the first time), the processing proceeds to step S817.

In step S819, the sequence management unit 202 searches the sequence state data 213 for the sequence identifier “0×0001” received in step S808. If the corresponding sequence identifier exists, the processing proceeds to step S820. If the corresponding sequence identifier does not exist, the processing proceeds to step S823.

In step S820, the sequence management unit 202 transmits the log output request including the sequence identifier “0×0001” to the components C1 and C2, based on the log output request destination data 211.

In step S821, the component C1 searches for and selects the log information 309 associated with the sequence identifier “0×0001” from the log information data 206, and outputs the log information 309 to the log output destination. The component C1 deletes the log information 309 stored in the heap memory area as the log information data 206.

In step S822, the component C2 searches for and selects the log information 409 associated with the sequence identifier “0×0001” from the log information data 206, and outputs the log information 409 to the log output destination, as in step S821. The component C2 deletes the log information 409 stored in the heap memory area as the log information data 206.

The sequence management unit 202 terminates the processing in step S823. The component C2 terminates the processing in step S824.

According to the present exemplary embodiment described above, the log output apparatus 101 outputs the log information of the sequential sequence processing in accordance with the execution time of the sequence processing. Thus, the log information is identified as the continuous sequential sequence processing, and the log output apparatus 101 can output the log information with high visibility, even when the sequence processing has not been completed within an expected time.

In a fifth exemplary embodiment, the log output apparatus 101 stores log information associated with a sequence identifier in a memory area, for each component. The log output apparatus 101 determines an output log level in accordance with an execution time of sequence processing, and outputs the log information corresponding to the sequence identifier from the memory area, in accordance with the output log level. The above described processing will be described in detail below.

The log output apparatus 101 according to the present exemplary embodiment has the same hardware configuration as that in the first exemplary embodiment.

A point of the functional configuration of the log output device 101 of the present exemplary embodiment illustrated in FIG. 2 different from the above described exemplary embodiments will be described.

The component 201 sets the first time in the sequence management unit 202.

The sequence management unit 202 measures the second time. The sequence management unit 202 compares the first time with the second time, and determines the output log level in accordance with the comparison result. Then, the sequence management unit 202 transmits the log output request including the sequence identifier and the output log level information to the component 201.

The sequence execution time upper limit setting unit 215 sets the first time.

The sequence execution time upper limit data 216 is data related to the first time. According to the present exemplary embodiment, the sequence management unit 202 stores the sequence execution time upper limit data 216 in the heap memory area.

The sequence time comparison unit 217 compares the sequence execution time upper limit data 216 (the first time) with the second time.

The sequence execution time measurement unit 218 measures the second time.

The log output request transmission unit 214 determines the output log level based on the comparison result of the sequence time comparison unit 217 and transmits the log output request including the sequence identifier and the output log level information to the component 201. More specifically, the log output request transmission unit 214 determines the output log level as “HIGH”, when the comparison result of the sequence time comparison unit 217 indicates that the second time is longer than the first time. The log output request transmission unit 214 determines the output log level as “LOW”, when the comparison result of the sequence time comparison unit 217 indicates that the second time is shorter than the first time (the second time is equal to or shorter than the first time). Then, the log output request transmission unit 214 transmits the log output request including the sequence identifier and the output log level information thus determined, to the component 201.

The component 201 searches for and selects the log information based on the sequence identifier and the output log level information received from the log output request transmission unit 214, and outputs the log information. The processing of searching and selecting the log information to be output by the component 201, based on the sequence identifier and the output log level information, has been described in the third exemplary embodiment by referring to FIGS. 6 and 7 as well as other figures, and thus will not be described.

According to the present exemplary embodiment described above, the log output apparatus 101 selects and outputs the log information of the sequential sequence processing in accordance with the output level determined based on the execution time of the sequence processing. Thus, the log information is identified as the continuous sequential sequence processing, and the log output apparatus 101 can accurately output the log information with high visibility, even when the sequence processing has not been completed within an expected time.

In a sixth exemplary embodiment, the log output apparatus 101 stores log information associated with a sequence identifier in a memory area, for each component. The log output apparatus 101 outputs the log information corresponding to the sequence identifier from the memory area, depending on whether an abnormal end of processing performed by the component 201 is detected. The above described processing will be described in detail below

The log output apparatus 101 according to the present exemplary embodiment has the same hardware configuration as that in the first exemplary embodiment.

A point of the functional configuration of the log output device 101 according to the present exemplary embodiment illustrated in FIG. 2 different from the above described exemplary embodiments will be described.

The sequence management unit 202 detects the abnormal end of the processing performed by the component 201, and specifies the sequence identifier related to the component 201 in which the abnormal end has occurred. The sequence management unit 202 determines whether the abnormal end of the processing executed by the component 201 is detected. The sequence management unit 202 transmits the log output request including the sequence identifier to the component 201, in accordance with the determination result.

The abnormal end detection unit 219 detects abnormal end of the processing executed by the component 201.

The log output request transmission unit 214 specifies the sequence identifier related to the processing executed by the component 201, in which the abnormal end has occurred. Then, the log output request transmission unit 214 transmits the log output request including the sequence identifier to the component 201.

The component 201 searches for and selects the log information based on the sequence identifier received from the log output request transmission unit 214, and outputs the log information. The processing of searching and selecting the log information to be output by the component 201, based on the sequence identifier, has been described in the first and other exemplary embodiments by referring to FIG. 6 and other figures, and thus will not be described.

In the present exemplary embodiment described above, the log output apparatus 101 outputs the log information of the sequential sequence processing depending on whether the abnormal end of the processing performed by the component 201 has occurred. Thus, the log information is identified as the continuous sequential sequence processing, and the log output apparatus 101 can output the log information with high visibility, even when the abnormal end of the processing performed by the component 201 occurs.

In a seventh exemplary embodiment, the log output apparatus 101 stores log information associated with a sequence identifier in a memory area, for each component. The log output apparatus 101 determines an output log level in accordance with whether an abnormal end of processing performed by the component 201 is detected, and outputs the log information corresponding to the sequence identifier from the memory area, in accordance with the output log level thus determined. The above described processing will be described in detail below.

The log output apparatus 101 of the present exemplary embodiment has the same hardware configuration as that in the first exemplary embodiment.

A point of the functional configuration of the log output device 101 according to the present exemplary embodiment illustrated in FIG. 2 different from the above described exemplary embodiments will be described.

The sequence management unit 202 detects the abnormal end, and specifies the sequence identifier related to the component 201, in which the abnormal end has occurred. The sequence management unit 202 determines whether the abnormal end of the component 201 is detected, and determines the output log level in accordance with the determination result. The sequence management unit 202 transmits the log output request including the sequence identifier and the determined output log level information to the component 201. More specifically, the log output request transmission unit 214 determines the output log level as “HIGH”, when the abnormal end of the processing executed by the component 201 is detected by the abnormal end detection unit 219. The log output request transmission unit 214 determines the output log level as “LOW”, when the abnormal end of the processing executed by the component 201 is not detected by the abnormal end detection unit 219. Then, the log output request transmission unit 214 transmits the log output request including the sequence identifier and the output log level information thus determined, to the component 201.

The component 201 searches for and selects the log information to be output based on the sequence identifier and the output log level information received from the log output request transmission unit 214, and outputs the log information. The processing of searching and selecting the log information to be output by the component 201, based on the sequence identifier and the output log level information, has been described in the third exemplary embodiment by referring to FIGS. 6 and 7 as well as other figures, and thus will not be described.

According to the present exemplary embodiment described above, the log output apparatus 101 selects and outputs the log information of the sequential sequence processing based on the output level determined in accordance with whether the abnormal end of the processing performed by the component 201 has occurred. Thus, the log information is identified as the continuous sequential sequence processing, and the log output apparatus 101 can output the log information with high visibility, even when the abnormal end of the processing performed by the component 201 occurs.

The exemplary embodiments are also realized as follows. Specifically, software (program) that realizes the functions according to the exemplary embodiments is supplied to a system or a device through a network or various storage mediums, and a computer (or a CPU or a micro processing unit (MPU)) of the system or the device reads out and executes the program.

According to the first to the seventh exemplary embodiments described above, an example is described where the execution unit of the component 201 and the sequence management unit 202 is per-program basis. Alternatively, the execution unit may be per-thread basis.

Furthermore, a case is described where the component 201 stores the log information data 206 in the heap memory area. Alternatively, the storage area may be a shared memory region or a thread specific data area.

Furthermore, a case is described where the sequence management unit 202 stores the log output request destination data 211 and the sequence state data 213 in the heap memory area. Alternatively, the storage area may be the shared memory region.

Furthermore, a case is described where the component 201 and the sequence management unit 202 operate on a single log output apparatus 101. Alternatively, the component 201 and the sequence management unit 202 may operate on different log output apparatuses.

The sequence processing may be realized by continuous a Remote Procedure Call, a Function Call, or any other communication systems.

According to the exemplary embodiments described above, recorded information of continuous sequential processing executed in a plurality of components is identified as the continuous sequential processing, and the log output device 101 can output the recorded information with high visibility.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

Embodiments of the present invention can also be realized by a computer of a system or apparatus that reads out and executes computer executable instructions recorded on a storage medium (e.g., a non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

This application claims the benefit of priority from Japanese Patent Application No. 2013-073339 filed Mar. 29, 2013, which is hereby incorporated by reference herein in its entirety.

What is claimed is:

1. An information processing apparatus including a processing execution unit related to execution of continuous sequential processing executed by a plurality of components, the processing execution unit comprising:
a communication unit configured to communicate a message including identification information for identifying the continuous sequential processing, with another processing execution unit;
a recording unit configured to record recorded information of the continuous sequential processing including the identification information included in the message communicated through the communication unit, in a memory area; and
an output unit configured to obtain and output the recorded information including the identification information from the recorded information recorded in the memory area, based on the identification information included in the message communicated through the communication unit.

2. The information processing apparatus according to claim 1, further comprising, at least one of:
a message transmission unit configured to transmit the message; and
a message reception unit configured to receive the message.

3. The information processing apparatus according to claim 1, further comprising a management unit configured to manage the continuous sequential processing executed by the processing execution unit,
wherein the processing execution unit further includes:
a transmission unit configured to transmit processing information of the continuous sequential processing including the identification information included in the message communicated through the communication unit, to the management unit; and
a request reception unit configured to receive an output request for the recorded information including the identification information included in the processing information transmitted by the transmission unit, from the management unit, and
wherein the output unit obtains and outputs the recorded information including the identification information from the recorded information recorded in the memory area, based on the identification information included in the output request received by the request reception unit.

4. The information processing apparatus according to claim 3, the management unit comprising:
a reception unit configured to receive the processing information transmitted by the transmission unit from the processing execution unit; and
a request transmission unit configured to transmit the output request for the recorded information corresponding to the identification information included in the processing information received by the reception unit, to the processing execution unit.

5. The information processing apparatus according to claim 4, wherein the request transmission unit transmits the output request for the recorded information when the processing information indicates that the continuous sequential processing has failed, and transmits a deletion request for the recorded information when the processing information indicates that the continuous sequential processing has been successful.

6. The information processing apparatus according to claim 4,
wherein the management unit further includes:
a measurement unit configured to measure an execution time of the execution of the continuous sequential processing; and
a comparison unit configured to compare the execution time measured by the measurement unit with an allowable execution time of the execution of the processing indicated by allowable execution time information included in the processing information received by the reception unit, and
wherein the request transmission unit transmits the output request for the recorded information when a result of comparison by the comparison unit indicates that the execution time exceeds the allowable execution time.

7. The information processing apparatus according to claim 4,
wherein the management unit further comprises a detection unit configured to detect an abnormal end of the continuous sequential processing, and
wherein the request transmission unit transmits the output request for the recorded information when the abnormal end is detected by the detection unit.

8. The information processing apparatus according to claim 4,
wherein the management unit further includes a determination unit configured to determine a level corresponding to a type of the recorded information for which the output request is issued to the processing execution unit, based on the processing information received by the reception unit, and
wherein the request transmission unit issues the output request for the recorded information of a type corresponding to the level determined by the determination unit, among types of the recorded information corresponding to the identification information included in the processing information.

9. The information processing apparatus according to claim 6,
wherein the management unit further includes a determination unit configured to determine a level corresponding to a type of the recorded information for which the output request is issued to the processing execution unit, based on a result of comparison by the comparison unit, and
wherein the request transmission unit issues the output request for the recorded information of a type corresponding to the level determined by the determination unit, among types of the recorded information corresponding to the identification information included in the processing information.

10. The information processing apparatus according to claim 7,
wherein the management unit further includes a determination unit configured to determine a level corresponding to a type of the recorded information for which the output request is issued to the processing execution unit, based on whether the abnormal end is detected by the detection unit, and
wherein the request transmission unit issues the output request for the recorded information of a type corresponding to the level determined by the determination unit, among types of the recorded information corresponding to the identification information included in the processing information.

11. The information processing apparatus according to claim 1, wherein the processing execution unit further includes a deletion unit configured to delete, when recorded information recorded in the memory area is output by the output unit, the recorded information from the memory area.

12. An information processing method executed by a processing execution unit related to execution of continuous sequential processing executed by a plurality of components, the information processing method comprising:
communicating a message including identification information for identifying the continuous sequential processing, with another processing execution unit;
recording recorded information of the continuous sequential processing including the identification information included in the communicated message; and
obtaining and outputting the recorded information including the identification information from the recorded information recorded in the memory area, based on the identification information included in the communicated message.

13. A computer readable storage medium storing a program causing a computer to function as a processing execution unit related to execution of continuous sequential processing executed by a plurality of components, the processing execution unit comprising:
a communication unit configured to communicate a message including identification information for identifying the continuous sequential processing, with another processing execution unit;
a recording unit configured to record recorded information of the continuous sequential processing including the identification information included in the message communicated through the communication unit, in a memory area; and
an output unit configured to obtain and output the recorded information including the identification information in the recorded information recorded in the memory area, based on the identification information included in the message communicated through the communication unit.
